(19) United States
(12) Patent Application Publication
(10) Pub. No.: US 2026/0039125 A1
(43) Pub. Date: Feb. 5, 2026

(54) BATTERY CONTROL DEVICE AND STORAGE MEDIUM PROGRAM

(71) Applicant: DENSO CORPORATION, Kariya-city (JP)

(72) Inventors: Mitsutaka ITO, Nisshin-city (JP); Taisuke Kurachi, Kariya-city (JP)

(73) Assignee: DENSO CORPORATION, Kariya-city (JP)

(21) Appl. No.: 19/297,617

(22) Filed: Aug. 12, 2025

Related U.S. Application Data
(63) Continuation of application No. PCT/JP2024/003300, filed on Feb. 1, 2024.

(30) Foreign Application Priority Data
Feb. 23, 2023 (JP) 2023-026810

(51) Int. Cl. H02J 7/00

(52) U.S. Cl. CPC H02J 7/0014; H02J 7/00712

(57) ABSTRACT

A battery control device has a relay control unit, that turns on and off a series relay and a parallel relay, and an input-output control unit, that controls the inputs and/or outputs power to and/or from the battery unit. When the relay control unit performs a voltage adjustment sequence to adjust the voltage difference between the plurality of battery packs by turning on and off the series relay and the parallel relay, the input-output control unit controls the input-output section to input or output power adjusted to suppress a circulation current based on a direction and a magnitude of the circulation current.

### CROSS-REFERENCE TO RELATED APPLICATIONS

The present application is a continuation application of International Application No. PCT/JP2024/003300 filed on Feb. 1, 2024, which claims priority to Japanese Application No. 2023-026810 filed on Feb. 23, 2023. The contents of these applications are incorporated herein by reference in their entirety.

### BACKGROUND

### 1. Technical Field

This disclosure relates to a battery control device and a storage medium storing a battery control program for controlling a battery circuit including a secondary battery module.

### 2. Related Art

JP2019122158A1 discloses a technology for suppressing inrush current. The inrush current occurs when charging a capacitive load using power from a servo power supply. In this technology, the servo power supply is connected to the current path connected with a high resistance resistor at the start of charging the capacitive load, the servo power supply is connected to the current path connected with a low resistance resistor when charging progresses, and then the servo power supply is connected to the current path without a resistance when charging progresses further. By switching the current path in this way, the increase in charging time due to a smaller charging current is suppressed.

### SUMMARY

This disclosure provides a battery control device that controls a battery circuit that includes a battery unit including a plurality of battery packs connected in parallel and an input-output section that inputs and/or outputs power to and/or from the battery unit. Each of the plurality of battery packs includes at least one battery module that is a rechargeable battery. At least one of the plurality of battery packs is a battery pack with a resistor that includes: the resistor connected in series to the battery module, a series relay connected in series to the resistor that turns wiring connections on and off, and a parallel relay connected in parallel with the resistor and the series relay that turns wiring connections on and off. The battery control device includes: a relay control unit, that turns on and off the series relay and the parallel relay, and an input-output control unit that controls an input and output power between the input-output section and the battery unit. The input-output control unit, when the relay control unit performs a voltage adjustment sequence to adjust the voltage difference between the plurality of battery packs by turning on and off the series relay and the parallel relay, controls input-output section to input or output power adjusted to suppress a circulation current based on a direction and a magnitude of the circulation current.

The present disclosure also provides a non-transitory computer-readable storage medium storing a program applied to a battery circuit that includes a battery unit including a plurality of battery packs connected in parallel and an input-output section that inputs and/or outputs power to and/or from the battery unit. Each of the plurality of battery packs includes at least one battery module that is a rechargeable battery. At least one of the plurality of battery packs is a battery pack with a resistor that includes: a resistor connected in series to the battery module, a series relay connected in series to the resistor that turns wiring connections on and off, and a parallel relay connected in parallel with the resistor and the series relay that turns wiring connections on and off. The program causes a computer to perform: a relay control step for turning on and off the series relay and the parallel relay, and an input-output control step for controlling an input and output power between the input-output section and the battery unit. The input-output control step includes, when a voltage adjustment sequence to adjust the voltage difference between the plurality of battery packs by turning on and off the series relay and the parallel relay is performed in the relay control step, controlling the input-output section to input or output power adjusted to suppress a circulation current based on a direction and a magnitude of the circulation current.

### BRIEF DESCRIPTION OF THE DRAWING

The above and other objects, features and advantages of the present disclosure will become clearer with the following detailed description with reference to the accompanying drawings. The drawings are:

FIG. 1 shows a battery control device and a battery circuit controlled by the battery control device according to a first embodiment,

FIG. 2 is a flowchart of the battery control process performed by the battery control device according to the first embodiment;

FIG. 3A-3D shows a voltage adjustment sequence where a circulation current is suppressed;

FIG. 4 is a time chart showing the voltage adjustment sequence where a circulation current is suppressed;

FIG. 5 is a flowchart for determining whether a request to suppress circulation current occurs;

FIG. 6 shows a battery control device and a battery circuit controlled by the battery control device according to a second embodiment,

FIG. 7A-7C shows a voltage adjustment sequence according to the second embodiment;

FIG. 8A-8D shows a voltage adjustment sequence according to a third embodiment;

FIG. 9 shows a battery circuit according to another embodiment;

FIG. 10 shows a battery circuit according to another embodiment;

FIG. 11 shows a battery circuit according to another embodiment.

### DETAILED DESCRIPTION OF THE PREFERRED EMBODIMENTS

The technology disclosed in JP2019122158A1 uses a relay as an example of a switching element for switching the current path. When a relay is used, if switching is performed while current is flowing in the relay, the relay may be damaged, which may cause the relay life to be reduced. On the other hand, if the life of the relay is to be ensured, it is necessary to increase the relay current-carrying capacity.

This disclosure aims to provide a battery control device and a storage medium storing a battery control program that can suppress the load on a relay when the relay is switched to adjust the voltage of a battery circuit.

This disclosure provides a battery control device that controls a battery circuit that includes a battery unit including a plurality of battery packs connected in parallel and an input-output section that inputs and/or outputs power to and/or from the battery unit. Each of the plurality of battery packs includes at least one battery module that is a rechargeable battery. At least one of the plurality of battery packs is a battery pack with a resistor that includes: the resistor connected in series to the battery module, a series relay connected in series to the resistor that turns wiring connections on and off, and a parallel relay connected in parallel with the resistor and the series relay that turns wiring connections on and off. The battery control device includes: a relay control unit, that turns on and off the series relay and the parallel relay, and an input-output control unit that controls an input and output power between the input-output section and the battery unit. The input-output control unit, when the relay control unit performs a voltage adjustment sequence to adjust the voltage difference between the plurality of battery packs by turning on and off the series relay and the parallel relay, controls input-output section to input or output power adjusted to suppress a circulation current based on a direction and a magnitude of the circulation current.

The above battery control device controls a battery circuit that includes a battery unit including a plurality of battery packs connected in parallel and an input-output section that inputs and/or outputs power to and/or from the battery unit. Each of the plurality of battery packs includes at least one battery module that is a rechargeable battery. At least one of the plurality of battery packs is a battery pack with a resistor that includes: a resistor connected in series to the battery module, a series relay connected in series to the resistor that turns wiring connections on and off, and a parallel relay connected in parallel with the resistor and the series relay that turns wiring connections on and off. The battery control device includes: a relay control unit that turns on and off the series relay and the parallel relay, and an input-output control unit, that controls an input and output power between the input-output section and the battery unit. The input-output control unit, when the relay control unit performs a voltage adjustment sequence to adjust the voltage difference between the plurality of battery packs by turning on and off the series relay and the parallel relay, controls the input-output section to input or output power adjusted to suppress a circulation current based on a direction and a magnitude of the circulation current. Since the voltage adjustment sequence is performed by turning on and off the series relay and the parallel relay while the circulation current is suppressed, the load on the relay when switching the relay to adjust the voltage difference in the battery circuit is suppressed. As a result, the life of the relays is ensured, which contributes to reducing replacement costs. In addition, it is possible to use a relay of which the capacity is smaller, contributing to lower component costs.

The present disclosure also provides a non-transitory computer-readable storage medium storing a program applied to a battery circuit that includes a battery unit including a plurality of battery packs connected in parallel and an input-output section that inputs and/or outputs power to and/or from the battery unit. Each of the plurality of battery packs includes at least one battery module that is a rechargeable battery. At least one of the plurality of battery packs is a battery pack with a resistor that includes: a resistor connected in series to the battery module, a series relay connected in series to the resistor that turns wiring connections on and off, and a parallel relay connected in parallel with the resistor and the series relay that turns wiring connections on and off. The program causes a computer to perform: a relay control step for turning on and off the series relay and the parallel relay, and an input-output control step for controlling an input and output power between the input-output section and the battery unit. The input-output control step includes, when a voltage adjustment sequence to adjust the voltage difference between the plurality of battery packs by turning on and off the series relay and the parallel relay is performed in the relay control step, controlling the input-output section to input or output power adjusted to suppress a circulation current based on a direction and a magnitude of the circulation current.

According to the storage medium storing the battery control program described above, when performing the voltage adjustment sequence to adjust the voltage difference of the plurality of battery packs by turning on and off the series relay and the parallel relay in the relay control step, the input-output control step is performed to control the input-output section to input or output power adjusted to suppress the circulation current, based on a direction and a magnitude of the circulation current. Since the voltage adjustment sequence is performed by turning on and off the series relay and the parallel relay when the circulation current is suppressed, the load on the relay for adjusting the voltage difference in the battery circuit is suppressed.

### First Embodiment

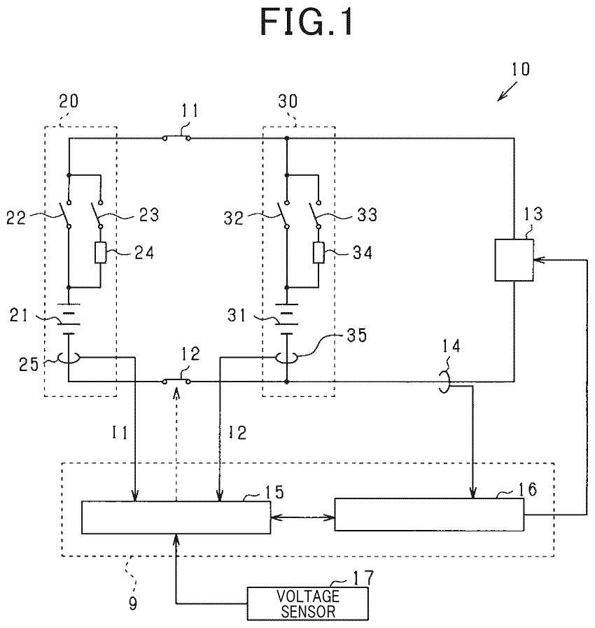

FIG. 1 shows a current control system including a battery control device 9 and a battery circuit 10 according to the first embodiment. The battery circuit 10 is controlled by the battery control device 9. The battery circuit 10 includes a battery pack including a first battery pack 20 and a second battery pack 30 connected in parallel, and an input-output section 13 that inputs and outputs power to the battery unit. The battery control device 9 includes a relay control unit 15 and an input-output control unit 16.

The first battery pack 20 and the second battery pack 30 are of similar configuration and designed to perform similarly. Similar performance may mean, for example, the same batteries and the same degree of degradation. The same battery may mean the same voltage rating, initial full charge capacity, and internal resistance. The same degree of degradation may mean the same current full charge capacity and internal resistance. The first battery pack 20 includes a first battery module 21 including a plurality of secondary batteries connected in series, a first parallel relay 22, a first series relay 23, and a first resistor 24 connected to a positive terminal of the first battery module 21, and a first current sensor 25 connected to a negative terminal of the first battery module 21. The secondary battery may be a lithium-ion battery. The first parallel relay 22, the first series relay 23 and the first resistor 24 may be connected to the negative terminal of the first battery module 21. The first series relay 23 is connected in series with the first resistor 24 and turns wiring connections on and off. The first parallel relay 22 is connected in parallel to the first resistor 24 and the first series relay 23 and turns wiring connections on and off. The first current sensor 25 detects the current of the first battery module 21 or the current of the first battery pack 20. The current control system further includes a voltage sensor 17. The voltage sensor 17 detects the voltage of the first battery module 21 and the voltage of the second battery module 31. The voltage sensor 17 may be provided for each of the battery packs 20, 30.

The second battery pack 30 includes a second battery module 31 including a plurality of secondary batteries connected in series, a second parallel relay 32, a second series relay 33 and a second resistor 34 connected to a positive terminal of the second battery module 31, and a second current sensor 35 connected to a negative terminal of the second battery module 31. The second parallel relay 32, second series relay 33 and second resistor 34 may be connected to the negative terminal of the second battery module 31. The second series relay 33 is connected in series with the second resistor 34 and turns wiring connections on and off. The second parallel relay 32 is connected in parallel with the second resistor 34 and the second series relay 33 and turns wiring connections on and off. The second current sensor 35 detects the current of the second battery module 31 or the current of the second battery pack 30.

Each of the first battery pack 20 and the second battery pack 30 is a battery pack with resistor that include a resistor connected in series to a battery module, a series relay connected in series with the resistor and turns wiring connections on and off, and a parallel relay connected in parallel with the resistor and the series relay and turns wiring connections on and off.

The positive terminals of the first battery pack 20 and the second battery pack 30 are connected with each other by a high voltage side relay 11 in a high voltage side. The negative terminals of the first battery pack 20 and the second battery pack 30 are connected with each other by a low voltage side relay 12 in a low voltage side. A circuit current sensor 14 is provided in a wiring connecting the negative terminals of the first battery pack 20 and the second battery pack 30 with the input-output section 13. The circuit current sensor 14 may be provided in a wiring connecting the positive terminals of the first battery pack 20 and the second battery pack 30 with the input-output section 13. The first battery pack 20, the second battery pack 30, the high voltage side relay 11, the low voltage side relay 12, and the circuit current sensor 14 constitute a battery unit in which a plurality of battery packs, including at least a rechargeable battery module, are connected in parallel.

The input-output section 13 is connected in parallel with the battery unit and inputs/outputs power to/from the battery unit. The input-output section 13 in this embodiment may be a device that can both input power from the battery unit and output power to the battery unit, such as a charging/discharging device, or it may be a device that can only input power from the battery unit or only output power to the battery unit. In the first embodiment, the case in which the input-output section 13 is a charging/discharging device will be illustrated as an example. For example, the battery unit may be mounted to a vehicle and connected to a charging/discharging device external to the vehicle, which may constitute the battery circuit 10. The battery control device 9 may be mounted to the vehicle or may be a device external to the vehicle that is connected to the vehicle.

The battery control device 9 is mainly composed of a well-known microcomputer including a CPU, ROM, RAM, flash memory, etc. For example, the CPU executes programs installed in ROM to realize the functions of relay control unit 15 and input-output control unit 16 and other functions provided by battery control device 9. The functions provided by the microcomputer may be provided by software stored in a substantive memory device and a computer executing it, software only, hardware only, or a combination thereof. For example, if the microcomputer is provided by an electronic circuit that is hardware, the electronic circuit may include digital or analog circuits containing many logic circuits. For example, the microcomputer executes a program stored on a non-transitory substantive storage medium as its own memory. The program includes, for example, a battery control program described below. When the program is executed, the method corresponding to the program is performed. The memory may be, for example, a nonvolatile memory. The program stored in the memory may be updated via a network such as the Internet.

The relay control unit 15, by turning on and off the high voltage side relay 11, the low voltage side relay 12, the first parallel relay 22, the first series relay 23, the second parallel relay 32, and the second series relay 33 respectively. The relay control unit 15 acquires detection data from the first current sensor 25 and the second current sensor 35. The input-output control unit 16, by controlling the input-output section 13, controls the input/output power between input-output section 13 and battery unit. The input-output control unit 16 acquires detection data from the circuit current sensor 14. The input-output control unit 16 may acquire the sum of the detection data from the first current sensor 25 and the second current sensor 35 instead of the detection data from the circuit current sensor 14.

The relay control unit 15 performs a voltage adjustment sequence to equalize the voltage of the first battery pack 20 and the second battery pack 30 by turning on and off the first parallel relay 22, the first series relay 23, the second parallel relay 32, and the second series relay 33 respectively. The voltage adjustment sequence is a sequence to suppress the occurrence of relay failures. The following is an example of a case in which the first battery module 21 and the second battery module 31 are charged by input-output section 13, which functions as a charging device. In this case, the first parallel relay 22 and the second parallel relay 32 are turned on and the first series relay 23 and the second series relay 33 are turned off. Depending on the degree of degradation of the battery module and other factors, charging may be completed in a state that the voltages of the first battery module 21 and second battery module 31 are unequal. When the charging current from input-output section 13 is cut off while the voltages are misaligned, inrush current and circulation current may flow from the battery module with the higher voltage to the battery module with the lower voltage among the first battery module 21 and second battery module 31. To suppress this circulation current, the voltage adjustment sequence is performed.

The input-output control unit 16 controls the input-output section 13 to input and output power adjusted to suppress circulation current based on a circulation current direction and a magnitude of the circulation current when the relay control unit 15 performs the voltage adjustment sequence. The circulation current direction is a direction of the circulation current flowing between the first battery pack 20 and the second battery pack 30. The first direction is defined as the direction of flow from the positive terminal of the first battery module 21 to the positive terminal of the second battery module 31, and the second direction is defined as the direction of flow from the positive terminal of the second battery module 31 to the positive terminal of the first battery module 21. The first direction is the circulation current direction in which the first battery module 21 is discharged and the second battery module 31 is charged, and the second direction is the circulation current direction in which the second battery module 31 is discharged and the second battery module 21 is charged. For example, based on the magnitude of the circulation current, the input-output control unit 16 calculates the command value of a circulation canceling current (hereinafter current command value Ich*) that is opposite to and has equal magnitude of the circulation current and controls the input/output power of the input-output section 13 based on the current command value Ich*. By this control, the circulation current is reduced by the circulation canceling current and the current flowing through the battery pack becomes smaller and approaches zero. The relay control unit 15 can execute on and off control of each of the parallel relay 22, the series relay 23, the parallel relay 32, and the series relay 33 while the circulation current is suppressed by the input-output control unit 16. As a result, the load on each of the first parallel relay 22, the first series relay 23, the second parallel relay 32, and the second series relay 33 is reduced. As a result, the life of each relay is lengthened, and replacement costs are reduced. In addition, it is possible to use each relay in which the capacity is smaller, and the cost of the parts is reduced.

The input-output control unit 16 estimates the magnitude and the direction of the circulation current based on the voltage of the first battery module 21 (hereinafter referred to as a first voltage V1) and the voltage of the second battery module 31 (hereinafter referred to as a second voltage V2) detected by the voltage sensor 17. For example, the input-output control unit 16 may estimate the magnitude and the direction of the circulation current based on the difference between the first voltage V1 and the second voltage V2 and the resistances of each of the first battery pack 20 and the second battery pack 30 (e.g., the resistances of each of the first battery module 21 and the second battery module 31). For example, the input-output control unit 16 may estimate the magnitude and direction of the circulation current using map information defining the relationship between the temperature of the first battery pack 20 and the second battery pack 30, and the resistances of the first battery pack 20 and the second battery pack 30. The input-output control unit 16 may estimate the magnitude and direction of the circulation current based on the detected values of the first current sensor 25 and the second current sensor 35, the first voltage V1, and second voltage V2. The input-output control unit 16 may, for example, estimate the larger magnitude of the circulation current as the difference between the first voltage V1 and the second voltage V2 is larger. For example, the input-output control unit 16 may estimate the direction of the circulation current is a direction flowing from the positive terminal of the first battery module 21 to the positive terminal of the second battery module 31 when the first voltage V1 is larger than the second voltage V2. The input-output control unit 16 may estimate the direction of the circulation current is a direction flowing from the positive terminal of the second battery module 31 to the positive terminal of the first battery module 21 when the first voltage V1 is smaller than the second voltage V2.

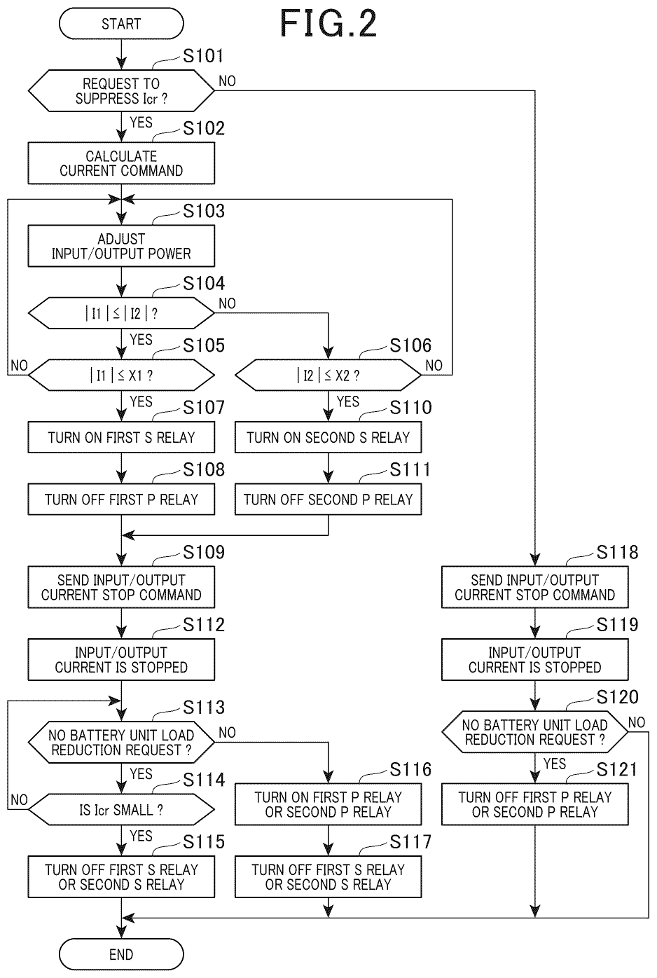

FIG. 2 shows a flowchart of a battery control process performed by the battery control device 9. The process shown in FIG. 2 is executed by the battery control device 9 when the CPU of battery control device 9 executes the battery control program installed in the ROM.

In step S101, the battery control device 9 determines whether a request to suppress the circulation current Icr flowing through each battery pack 20 and 30 is received or occurs. When it determines that there is such a request, the process proceeds to step S102.

Each of the steps shown in steps S102 to S106 is a step to control the input/output power between the input-output section 13 and the battery unit. These steps are examples of an input-output control step for controlling the input-output section 13 to input or output power adjusted to suppress the circulation current based on the circulation current direction and the magnitude of the circulation current.

In step S102, the battery control device 9 calculates the current command value Ich*, which is a command value of input/output current to suppress circulation current. In step S103, the battery control device 9 controls the input/output power of the input-output section 13 based on the current command value Ich*.

In step S104, the battery control device 9 determines whether the absolute value of the first current value I1 detected by the first current sensor 25 is less than or equal to the absolute value of the second current value I2 detected by the second current sensor 35. When it is determined that |I1|≤|I2|, the battery control device 9 proceeds to step S105 and determines whether the absolute value of the first current value I1 is less than or equal to the first current threshold X1. The first current threshold X1 is a current switching threshold and is set to a current value that can ensure the desired lifetime in each of the relays 22, 23 in the first battery pack 20. The relationship between the current flowing through the relay and the life of the first current threshold X1 can be derived by experiment or other means. When it is determined that |I1|≤X1, the battery control device 9 proceeds to step S107. When it is determined that |I1|>X1, the battery control device 9 proceeds to step S103.

On the other hand, when it is determined that |I1|>|I2| in step S104, the battery control device 9 proceeds to step S106 and determines whether the absolute value of the second current value I2 is less than or equal to the second current threshold X2. The second current threshold X2 is a current switching threshold and is set to a current value that can ensure the desired lifetime in each of the relays 32, 33 in the second battery pack 30. When it is determined that |I2|≤X2, the battery control device 9 proceeds to step S110. When it is determined that |I2|>X2, the battery control device 9 proceeds to step S103.

In step S107, the battery control device 9 turns on the first series relay (first S relay in the figure), 23 and then proceeds to step S108. In step S108, after turning off the first parallel relay (first P relay in the FIG. 22, it proceeds to step S109.

On the other hand, in step S110, after turning on the second series relay (second S relay in the FIG. 33, the battery control device 9 proceeds to step S111. In step S111, after turning off the second parallel relay (second P relay in the FIG. 32, it proceeds to step S109.

Each of the processes shown in steps S107, S108, S110, and S111 corresponds to a voltage adjustment sequence in which the voltage difference between the first battery pack 20 and the second battery pack 30 is adjusted by on and off control of the first parallel relay 22 and the first series relay 23 or the second parallel relay 32 and the second series relay 33. Each of the processes shown in steps S107, S108, S110, and S111 is a step to control the on and off state of series relay and parallel relay. This step corresponds to the relay control step, which performs the voltage adjustment sequence to adjust the voltage difference between multiple battery packs by on and off control of series relay and parallel relay.

In step S109, the input-output control unit 16 sends an input/output current stop command to the input-output section 13. As a result, the input/output current flowing between the battery circuit 10 and the input-output section 13 is stopped in step S112. With the switching control of each relay for the voltage adjustment sequence completed, when the input/output current stops, the voltage between each battery pack 20 and 30 is adjusted to be smaller by the circulation current Icr.

In step S113, the battery control device 9 determines whether a battery unit load reduction request is received or occurs. When the battery control device 9 determines that there is no battery unit load reduction request in step S113, it proceeds to step S114.

In step S114, the battery control device 9 determines whether the magnitude of the circulation current Icr has decreased to a value in which the voltage adjustment sequence is not necessary to be performed. For example, the battery control device 9 may determine that the magnitude of the circulation current Icr has decreased to the value when the difference between the first voltage V1 and the second voltage V2 is less than a predetermined voltage threshold.

When the battery control device 9 obtains a negative determination result in step S114, it proceeds to step S113. On the other hand, when the battery control device 9 makes a positive determination in step S114, it proceeds to step S115. In step S115, when the process of step S107 has been performed, the battery control device 9 turns off the first series relay 23. On the other hand, in step S115, when the process of step S110 has been performed, the battery control device 9 turns off the second series relay 33.

When the battery control device 9 determines that there is the battery unit load reduction request in step S113, the battery control device 9 proceeds to step S116. In step S116, when the process of step S108 has been performed, the battery control device 9 turns on the first parallel relay 22. On the other hand, in step S116, when the process of step S111 has been performed, the battery control device 9 turns on the second parallel relay 32.

Then the battery control device 9 proceeds to step S117. When the process of step S107 has been performed, the battery control device 9 turns off the first series relay 23. On the other hand, in step S117, when the process of step S110 has been performed, the battery control device 9 turns off the second series relay 33.

When the battery control device 9 determines that the request to suppress the circulation current Icr is not received or does not occur in step S101, it proceeds to steps S118 and S119. In steps S118 and S119, the battery control device 9 performs the same processing as in steps S109 and S112.

In step S120, the battery control device 9 performs the same processing as in step S113. When the battery control device 9 determines that there is no battery unit load reduction request in step S120, the battery control device 9 proceeds to step S121 and turns off the relays that are in the on-state among the first parallel relays 22 and the second parallel relay 32.

According to the battery control process of the first embodiment, when the request to suppress circulation current Icr is received or occurs in step S120, the current command value Ich* is calculated. The current command value Ich* is a command value of the circulation canceling current value. By adjusting the input/output current in the input/output control step, the circulation current Icr is appropriately suppressed. The relay control steps shown in steps S107, S108, S110, and S111 are performed on the condition that the currents flowing through the wires in each battery pack 20 or 30 (the first current value I1 or the second current value I2) are less than the current switching threshold (the first current threshold X1 or the second current threshold X2), and the voltage adjustment sequence is performed. As a result, the life of the relays in each battery pack 20 and 30 is ensured.

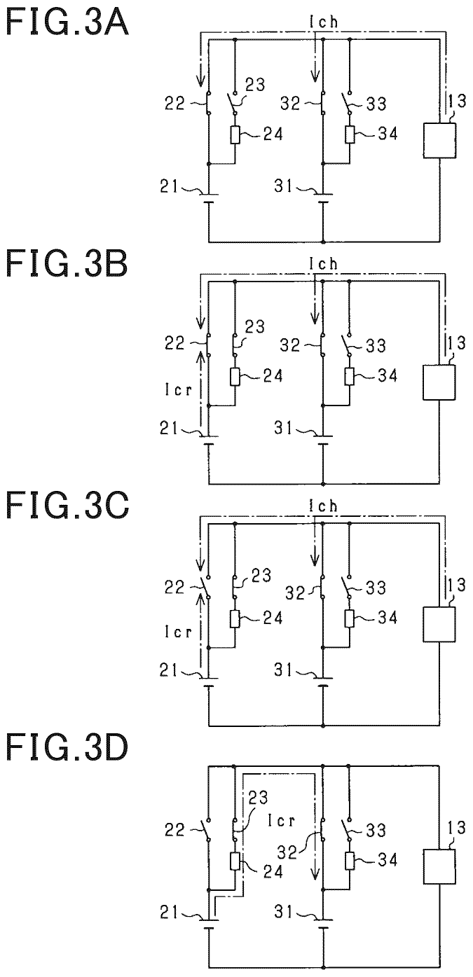

FIGS. 3A-3D describe the voltage adjustment sequence that suppresses the circulation current performed by the battery control process. FIGS. 3A-3D are schematic diagrams of the battery circuit 10 shown in FIG. 1. FIG. 3A shows the state in which the first battery module 21 and second battery module 31 being charged. The first parallel relay 22 and the second parallel relay 32 are in the on-state, and the charging current Ich is flowing from the input-output section 13 to the battery unit.

When the charging of the first battery module 21 and the second battery module 31 is completed, the request to suppress the circulation current occurs. In this case, by the input-output control step the charging current Ich from the input-output section 13 is controlled to gradually approach the current command value Ich*, which is the commanded value of the circulation canceling current. As the charging current Ich gradually approaches the current command value Ich*, the first current value I1 and the second current value I2 are also gradually reduced.

Then, when |I1|≤X1 is satisfied, the first series relay 23 is turned on, as shown in FIG. 3B. Then, as shown in FIG. 3C, the first parallel relay 22 is turned off. Then, as shown in FIG. 3D, when the input/output current of the input-output section 13 is stopped, the circulation current Icr flows in the closed circuit composed of the first battery module 21, the first resistor 24, the first series relay 23, the second parallel relay 32, and the second battery module 31. As a result, the voltage difference between the first battery pack 20 and the second battery pack 30 is reduced. In this case, the inclusion of the first resistor 24 in the closed circuit enhances the effect of reducing the circulation current Ich.

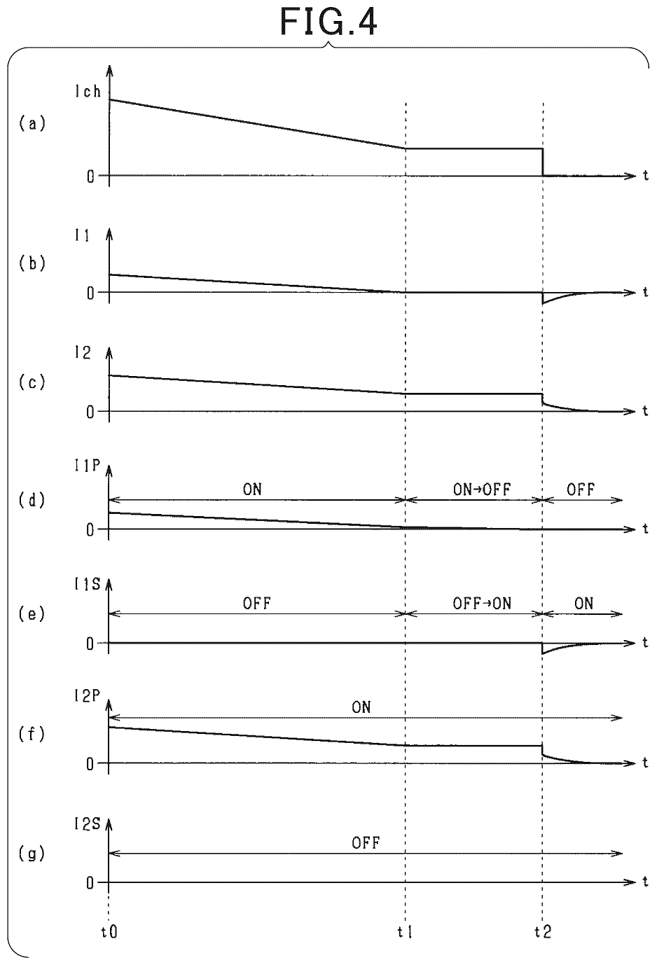

FIG. 4 shows a time chart related to the voltage adjustment sequence performed as the battery control process. The vertical axes in sections (a) to (g) of FIG. 4 show, respectively, the input/output currents, the charging current Ich, the first current value I1, the second current value I2, the current value I1P of the current flowing through the first parallel relay 22, the current value I1S of the current flowing through the first series relay 23, the current value I2P of the current flowing through the second parallel relay 32, the current value I2S of the current flowing through the series relay 33. The horizontal axis indicates time t. The on and off state of each relay is shown together in sections (d) to (g) of FIG. 4. In FIG. 4, the first current value I1 is defined as positive when it flows in the direction from the positive terminal to the negative terminal in the first battery module 21. The second current value I2 is defined as positive when it flows in the direction from the positive terminal to the negative terminal in the second battery module 31. The charging current Ich is defined as positive when it is output from the input-output section 13. The current values I1P, I1S, I2P, and I2S flowing through each relay are defined as positive when they flow from the side of the high voltage side relay 11 to the side of the low voltage side relay 12.

The time chart in FIG. 4 corresponds to the states in FIGS. 3A-FIG. 3D. The period t=t0 to t1 in FIG. 4 corresponds to the state in FIG. 3A. At the period t=t0 to t1, as the charging current Ich gradually decreases, the first current value I1, the second current value I2, the current value I1P, and the current value I2P gradually decrease. Since the series relay 23 and the series relay 33 are in the off-state, the current values I1S and I2S remain constant at zero.

The period t=t1 to t2 in FIG. 4 corresponds to the states in FIG. 3B and FIG. 3C. At the period t=t1 to t2, the charging current Ich is maintained at a current value suitable for the circulation canceling current. Since the circulation canceling current is in balance with the circulation current Icr flowing through the first parallel relay 22, the first current value I1 remains generally constant at zero during this period. The second current value I2 and the current value I1S are constant values but are not generally in a state of zero. Since the second series relay 33 is in the off-state, the current value I2S remains generally constant at zero. During this period, the battery control device 9 turns on the first series relay 23 and then turns off the first parallel relay 22. The input/output current at the input-output section 13 is controlled to be at the current command value Ich*, which cancels the circulation current. Therefore, the current flowing in each battery pack 20 and 30 is reduced without interrupting the battery circuit 10. This allows each relay to be turned on or off while the current flowing to each battery pack 20 and 30 is reduced, thus ensuring the life of the relay.

After time t=t2 in FIG. 4 corresponds to the state shown in FIG. 3D. At time t=t2, when the input/output current stop command is sent to the input-output section 13, the charging current Ich decreases to zero in an almost stepwise manner. Thereafter, the first current value I1 and the second current value I2 gradually converge to zero. Since the first series relay 23 and the second parallel relay 32 are in the on-state, the current values I1S and I2P also gradually converge to zero after time t=t2 in the same manner. As shown in FIG. 3D, the battery control device 9 performs relay control so that the first series relay 23 is in the on-state, the first parallel relay 22 is in the off-state, and the input/output current is stopped after the first resistor 24 is included in the current path. By this control, the large current flowing at the stop time (time t=t2) is suppressed. Since the first parallel relay 22 and the second series relay 33 are in the off-state, the current values I1P and I2S remain constant at zero.

As explained above, the relay control unit 15 turns off the parallel relay after turning on the series relay when the current flowing through at least one battery pack with resistor becomes less than or equal to the predetermined current switching threshold during the voltage adjustment sequence. Therefore, each relay is turned on or off while the load to each relay is suppressed, and the life of the relay is ensured. Even if each battery pack 20 and 30 has the same configuration, the voltage of each battery module 21 and 31 may differ, for example, due to differences in the degree of deterioration of each battery module 21 and 31. If input/output power is stopped in this state, there is concern that a large inrush current or circulation current may flow from the battery pack with the higher voltage to the battery pack with the lower voltage. According to this method, the circulation current Icr is suppressed as the input/output current is controlled using the current command value*, and each relay is switched while the load to each relay is suppressed. The current command value* is equivalent to the circulation canceling current value.

When the input-output control unit 16 controls the input-output section 13 so that the charging current to the battery unit flows, the relay control unit 15 switches the current path by controlling the series relay and the parallel relay, which are included in the battery pack with resistor in which the circulation current Icr is in a discharge direction. In the example shown in FIGS. 3A-3D the battery pack with resistor in which the circulation current Icr is in the discharge direction is the first battery pack 20 with the first battery module 21. By controlling the charging current from the input-output control unit 16 to the battery unit to be at the current command value Ich*, each relay turns on and off while the circulation current Icr is suppressed. The current command value Ich* is equivalent to circulation canceling current value. Therefore, the load to each relay is suppressed and the life of the relay is ensured.

FIGS. 3A-3D and FIG. 4 describe the case in which the input-output control unit 16 controls the input-output section 13 so that the charge current flows to the battery unit, but the same is true for the case in which the input-output control unit 16 controls the input-output section 13 so that the discharge current flows from the battery unit to the input-output control unit 16. In this case, the relay control unit 15 switches the current path by controlling the series relay and the parallel relay included in the battery pack with resistor in which the circulation current Icr is in a charge direction. By controlling the discharge current from the battery unit to the input-output control unit 16 to be at the current command value Ich*, each relay is turned on or off while the circulation current Icr is suppressed. The current command value Ich* corresponds to the circulation canceling current value. Therefore, the load to each relay is suppressed and the life of the relay is ensured.

As explained using FIG. 2-FIG. 4, after the relay control unit 15 turns on the series relay, the parallel relay is turned off and then the input-output control unit 16 controls the input-output section 13 to stop inputting or outputting the power adjusted to suppress the circulation current Icr. Since the input/output current is stopped after the current path is made to include a resistance, the large current that flows when the input/output current is stopped is suppressed.

The input-output control unit 16 may estimate the current direction and the magnitude of the circulation current Icr based on the voltage of each battery module 21 and 31 or each battery pack 20 and 30, and the internal resistance of each battery module 21 and 31. Furthermore, the input-output control unit 16 may control input-output section 13 to input/output power adjusted to suppress the circulation current Icr when the circulation current Icr exceeds the upper limit of chargeable/dischargeable current Ib_max of each battery module 21 and 31. The current flowing as the circulation current Icr is reduced and the time required for voltage adjustment is reduced.

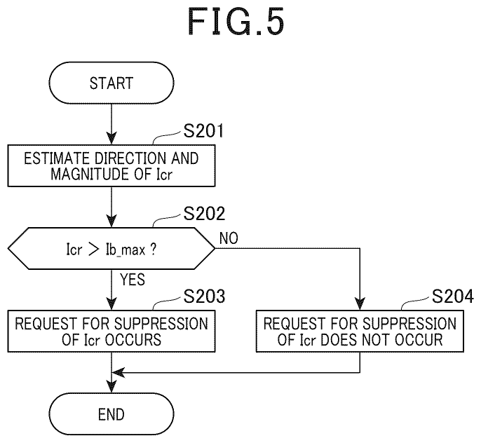

FIG. 5 shows a specific example of the processing of step S101 shown in FIG. 2. In step S201 shown in FIG. 5, the battery control device 9 estimates the current direction and the magnitude of the circulation current Icr and proceeds to step S202.

In step S202, the battery control device 9 determines whether the magnitude of the circulation current Icr exceeds the upper limit (Ib_max) of the chargeable and dischargeable currents of the first and second battery modules 21 and 31 based on the estimation result of step S201. When Icr>Ib_max, the battery control device 9 proceeds to step S203 and determines that the request for suppression of the circulation current Icr occurs. When Icr≤Ib_max, the battery control device 9 proceeds to step S204 and determines that there is the request for the suppression of circulation current Icr does not occur.

The resistance of each battery pack with resistor may be adjustable based on a predetermined battery parameter that affects the circulation current Icr. Then, the current flowing as the circulation current Icr is effectively reduced and the time required for the voltage adjustment is reduced. For example, the resistance may be adjusted by adjusting the number of resistors. The resistance may be adjusted in other ways.

The predetermined battery parameters that affect circulation current Icr may be, for example, a voltage, a temperature, a degradation (SOH), and an internal resistance of each battery module 21 and 31 but may be other parameters. When the predetermined battery parameter is the voltage of each battery module 21 and 31, it is preferable to increase the number of resistors to increase the resistance value as the voltage difference is higher, because the higher voltage difference between each battery module 21 and 31 causes the larger circulation current Icr. For example, the input-output control unit 16 may turn on and off relays 22, 23, 32 and 33 to include both the first and second resistors 24 and 34 in the current path as a process to increase the number of resistors. When the predetermined battery parameter is the temperature, it is preferable to increase the number of resistors to increase the resistance value because the higher temperature causes the larger circulation current Icr. When the predetermined battery parameter is the degradation, it is preferable to increase the number of resistors to increase the resistance value because the higher degradation causes the larger circulation current Icr. When the predetermined battery parameter is the internal resistance, it is preferable to decrease the number of resistors to reduce the resistance value, because the higher internal resistance causes the smaller circulation current Icr. By adjusting the resistance value in this way, inrush current and the circulation current Icr are effectively suppressed. The temperature and the degradation of each battery module 21 and 31 have a relationship with the internal resistance, and a high temperature state and a high degradation state correspond to a low internal resistance state respectively.

When there is the battery unit load reduction request, the relay control unit 15 terminates the voltage adjustment sequence by turning on the parallel relay and then turns off the series relay. This allows discharging from the battery module according to the load demand from the parallel relay side, which does not include a resistor in the current path. When there is no battery unit load reduction request, the relay control unit 15 terminates the voltage adjustment sequence by turning off the series relay. This can suppress unnecessary execution of the process of turning on the parallel relay.

When there is the battery unit load reduction request when the series relay is in the on-state, the input-output control unit 16 controls the input-output section 13 to input and output power adjusted to suppress the circulation current Icr, and the relay control unit 15 may turn on the parallel relay after the series relay is turned off. This allows turning on and off each relay to be executed while the circulation current Icr is suppressed, the load on each relay is suppressed, and the life of the relays are ensured.

The relay control unit 15 may estimate the estimated value of circulation current Icr in a case that the parallel relay is turned on while the series relays are in the on-state, and switch the parallel relay to the on state when the estimated value of circulation current Icr is less than the upper limit of charge/dischargeable current of the battery module, Ib_max. This can reduce the current value flowing as circulation current Icr and shorten the time required for potential adjustment.

### Second Embodiment

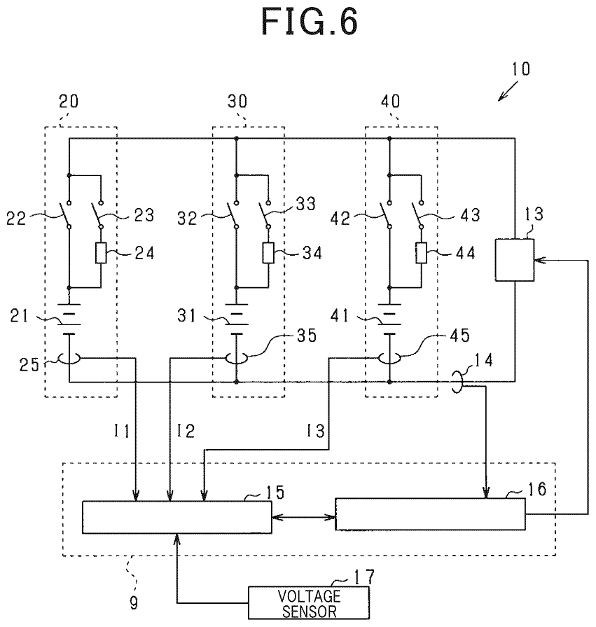

In the first embodiment, two battery packs are connected in parallel to form a battery unit, but it is not limited to this. Three or more battery packs may be connected in parallel to form a battery unit. In a second embodiment, three battery packs are connected in parallel as shown in FIG. 6.

The battery circuit shown in FIG. 6 differs from the battery circuit 10 shown in FIG. 1 in that a third battery pack 40 is provided between the second battery pack 30 and the input-output section 13. The third battery pack 40 includes a third battery module 41 including a plurality of secondary batteries connected in series, and a third parallel relay 42, a third series relay 43, and a third resistor 44, each connected to the positive terminal of the third battery module 41. The third battery pack 40, like the other battery packs 20 and 30, has a third current sensor 45 connected to the negative terminal of the third battery module 41. The third current sensor 45 detects the current of the third battery module 41 or the current of the third battery pack 40. The detected value of the third current sensor 45 (hereinafter referred to as the third current value I3) is input to the relay control unit 15. The voltage sensor 17 detects the voltage of the third battery module 41. The battery voltage detected by the voltage sensor 17 is not limited to the voltage between the terminals of the battery module but may be the voltage of the battery cells consisting of the battery module.

In FIG. 6, the high voltage side relay 11, the low voltage side relay 12, and the positive and low voltage side relays between the second battery pack 30 and the third battery pack 40 are not shown. The third parallel relay 42, third series relay 43 and third resistor 44 may be connected to the negative terminal of the third battery module 41.

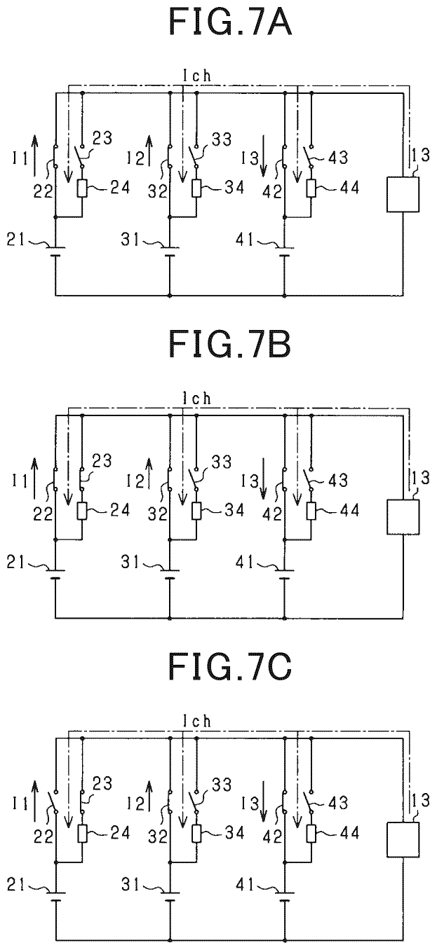

FIGS. 7A to 7C schematically illustrates the states of the battery circuits respectively. In these figures, the case where the input-output section 13 functions as a charging device is shown.

As shown in FIG. 7A, each of the first parallel relay 22, second parallel relay 32 and the third parallel relay 42 is in the on-state and the charge current Ich flows from the input-output section 13 to the battery unit.

In the following, the direction of circulation current flowing in the first battery module 21 and second battery module 31 is the direction of discharge from the first battery module 21 and second battery module 31, and the direction of circulation current flowing in the third battery module 41 is the direction of charge the third battery module 41.

The input-output control unit 16 identifies the battery modules in which the direction of circulation current is the discharge direction based on the first voltage V1, the second voltage V2, and the voltage of the third battery module 41 detected by the voltage sensor 17 (hereinafter referred to as the third voltage V3). In the example shown in FIGS. 7A to 7C, the input-output control unit 16 identifies the first battery module 21 and the second battery module 31 as the battery modules in which the direction of circulation current is the discharge direction.

The input-output control unit 16 identifies the battery modules in which the magnitude of the circulation current Icr is smallest among the first battery module 21 and second battery module 31 in which the direction of circulation current Icr is the discharge direction, based on the first voltage V1, the second voltage V2, and the third voltage V3. In the example shown in FIGS. 7A to FIG. 7C, the input-output control unit 16 identifies the first battery module 21 is the battery modules in which the magnitude of the circulation current is smallest.

The input-output control unit 16 controls the output power of input-output section 13 so that the absolute value of the first current value I1 flowing through the first battery pack 20, where the magnitude of the circulation current is minimum, is less than the current switching threshold (first current threshold X1). For example, the input-output control unit 16 calculates the current command value Ich* and controls the output power of the input-output section 13 so that the charging current supplied from the input-output section 13 to the first battery module 21 is the same as the magnitude of the circulation current Icr flowing in the first battery module 21. This allows the circulation current to be suppressed and the charging current output from input-output section 13 to be minimized.

Then, the relay control unit 15 turns on the first series relay 23 while |I1|≤X1 is satisfied as shown in FIG. 7B and turns off the first parallel relay 22 as shown in FIG. 7C. Although not shown in the figure, the relay control unit 15 may stop the input/output current of input-output section 13 as in the state shown in FIG. 3D.

In the second embodiment, the battery unit includes first to third battery packs 20, 30, and 40, which are three battery packs with respective resistor connected in parallel with each other. For example, the input-output control unit 16 may control the input/output power by the input-output section 13 so that the current flowing through the battery pack in which the magnitude of circulation current Icr is the smallest among the first to third battery packs 20, 30, and 40, is less than the current switching threshold (the first current threshold X1). This makes it possible to perform the voltage adjustment sequence with the input/output power by input-output section 13 suppressed to a minimum.

The input-output control unit 16 may determine whether the current between the input-output section 13 and the battery unit is a charging current or a discharging current according to the direction of the current flowing through the series relay or the parallel relay included in the battery pack with resistor in which the magnitude of circulation current Icr is smallest.

Instead of the input-output section 13 functioning as a charging device, the input-output section 13 may function as a discharging device, or the input-output section 13 may function as a charging/discharging device. First, the case in which the input-output section 13 functions as a discharge device (e.g., DCDC converter) is described. The discharge device has the function of accepting power from the battery module.

The input-output control unit 16 identifies the battery module in which the direction of circulation current is the charge direction based on the first to third voltages V1 to V3. In the example described below, the input-output control unit 16 identifies the first battery module 21 and the second battery module 31 as the battery module in which the direction of circulation current is the charge direction.

Based on the first to third voltages V1 to V3, the input-output control unit 16 identifies the battery module in which the magnitude of the circulation current is smallest among the first battery module 21 and the second battery module 31 in which the direction of circulation current is the charge direction. In the example described below, the input-output control unit 16 identifies the first battery module 21 as the battery module in which the magnitude of the circulation current is smallest.

The input-output control unit 16 controls the input power of the input-output section 13 so that the absolute value of the first current value I1 flowing through the first battery pack 20, which has the smallest magnitude of circulation current, is less than the current switching threshold (the first current threshold X1). For example, the input-output control unit 16 may calculate current command value Ich* and control the input power of the input-output section 13 so that the discharge current flowing from the battery module 21 to the input-output section 13 is the same as the magnitude of circulation current flowing through battery module 21. Then, while |I1|≤X1 is satisfied, the relay control unit 15 turns on the series relay 23, an then turns off the parallel relay 22.

The following section describes the case in which the input-output section 13 functions as either a discharging or a charging device.

The input-output control unit 16 identifies the battery module in which the direction of circulation current is the charge direction based on the first to third voltages V1 to V3. In the example described below, the input-output control unit 16 identifies the first battery module 21 as the battery module in which the direction of circulation current is the charge direction. The input-output control unit 16 determines whether the direction of the circulation current flowing in the first battery module 21 is the charge direction or the discharge direction of the first battery module 21.

When the input-output control unit 16 determines that the direction of the circulation current flowing in the first battery module 21 is the discharge direction, the input-output control unit 16 calculates the current command value Ich* and controls the output power of the input-output section 13 so that the charging current supplied from the input-output section 13 to the first battery module 21 is the same as the magnitude of the circulation current flowing in the first battery module 21.

On the other hand, when the input-output control unit 16 determines that the direction of the circulation current flowing into the first battery module 21 is the charge direction, the input-output control unit 16 calculates the current command value Ich* so that the discharge current flowing from the first battery module 21 to the input-output section 13 is the same as the magnitude of the circulation current flowing into the first battery module 21, and controls the input power of input-output section 13.

### Third Embodiment

In each of the above embodiments, the relay switching for the voltage adjustment sequence was performed in only one battery pack among the plurality of battery packs with respective resistor constituting the battery unit but is not limited to. The voltage adjustment sequence may be performed in multiple battery packs.

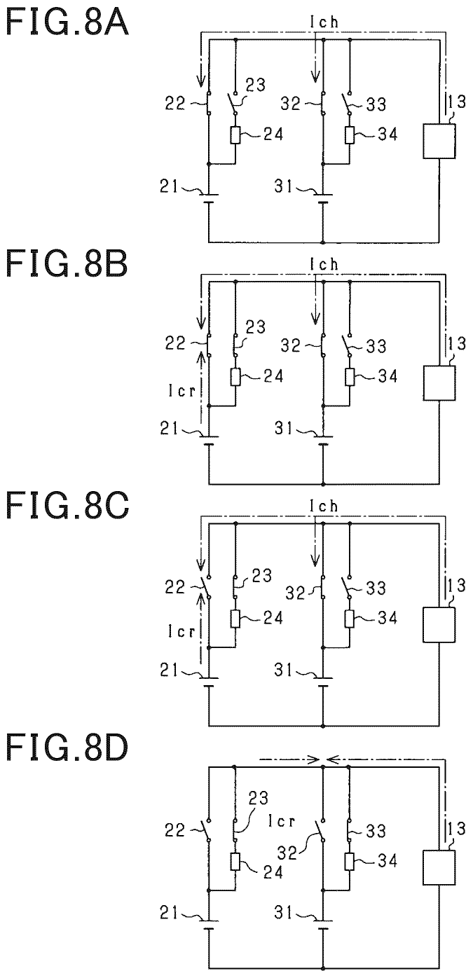

Each of the figures in FIG. 8 is a schematic drawing of the battery circuit 10 shown in FIG. 1, as in FIGS. 3A-3D. FIG. 8A, same as in FIG. 3A, shows the first battery module 21 and the second battery module 31 in the charged state. The first parallel relay 22 and second parallel relay 32 are in the on-state, and the charging current Ich is flowing from the input-output section 13 to the battery unit. When the charging of first battery module 21 and the second battery module 31 is completed, the request for suppression of the circulation current occurs and in the input-output control step, the charge current Ich is controlled to gradually decrease toward the current command value Ich *. The current command value Ich* corresponds to the circulation canceling current value. As the charging current Ich gradually decreases toward the current command value Ich*, the first current value I1 and the second current value I2 also gradually decreases.

When |I1|≤X1 is satisfied, the relay control unit 15 turns on the first series relay 23, as shown in FIG. 8B. Then, the relay control unit 15 turns off the first parallel relay 22, as shown in FIG. 8C. Subsequently, when |I2|≤X2 is satisfied, the relay control unit 15 turns on the second series relay 33 and then turns off the second parallel relay 32, as shown in FIG. 8D. Although not shown in the figure, the input/output current of the input-output section 13 is then stopped as shown in FIG. 3D. When the voltage of the plurality of battery packs with respective resistor that constitute the battery unit is high, the large current flowing at the time of stopping of the input/output power is effectively suppressed by performing the turning on or off the relay for the voltage adjustment sequence using multiple resistors (the first resistor 24 and the second resistor 34). For example, a plurality of voltage thresholds of different values may be set for the voltages of the plurality of battery packs with respective resistor constituting the battery unit, and the larger the voltage threshold is exceeded, it is preferable to use the more the number of resistors to perform turning on or off the relay for the voltage adjustment sequence.

### Variants

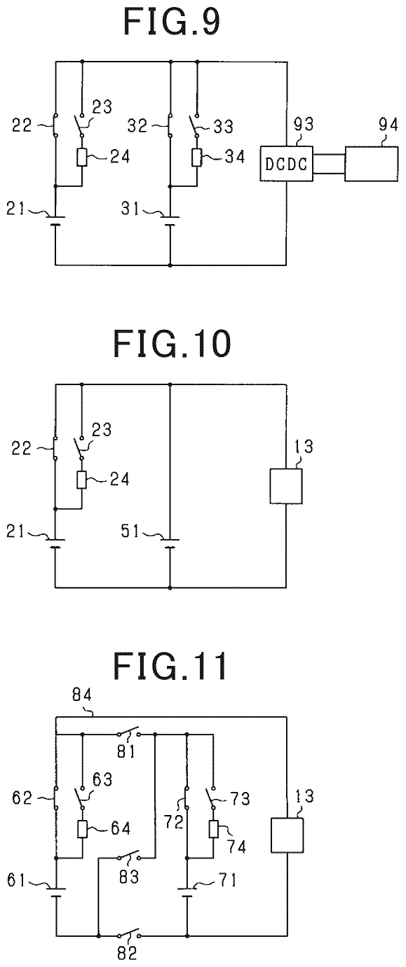

In each of the above embodiments, the case in which the input-output section 13 is a charging/discharging device is illustrated and explained but is not limited to. For example, as shown in FIG. 9, the input-output section 13 may be a DC-DC converter 93 connected to a vehicle's auxiliary battery 94. Or the input-output section 13 may be an air compressor, heater, or other load. As mentioned above, the input-output section in this application is not limited to a configuration that allows both input and output but may also have only one of the functions of either input or output power.

In each of the above embodiments, the case in which the battery unit is configured by the battery packs with respective resistor, each of the battery packs being connected in parallel with each other is illustrated and explained as an example but is not limited to. For example, as shown in FIG. 10, a battery unit may be composed of battery packs including similar one to the first battery pack 20 and a battery pack that does not include resistors, series relay and parallel relay, but only includes battery module 51, connected in parallel with each other. The battery pack with resistor should be included in at least one of the battery packs connected in parallel with each other to form a battery unit.

As shown in FIG. 11, the battery unit may be configured to switch the connection state of each battery pack to parallel or series. In this case, the battery control method described above can be applied when each battery pack is connected in parallel. As shown in FIG. 11, the left battery pack includes a battery module 61, a parallel relay 62, a series relay 63, and a resistor 64. The right battery pack includes a battery module 71, a parallel relay 72, a series relay 73, and a resistor 74. The left battery pack and the right battery pack are connected with each other by relays 81 to 83. The relay 81 connects the positive terminal of each battery pack with each other. The relay 82 connects the negative terminal of each battery pack with each other. The relay 83 connects the negative terminal of the battery module 61 with the high voltage side of the parallel relay 72 and the series relay 73. A wiring 84 connects the positive terminal of input-output section 13 with the low voltage side of the parallel relay 62 and the series relay 63. By turning off the relay 83 and turning on the relay 81 and the relay 82, each battery pack can be connected in parallel. By turning on the relay 83 and turning off the relay 81 and the relay 82, each battery pack can be connected in series.

According to each of the above embodiments, the following effects can be obtained.

The battery control device 9 controls the battery circuit 10 including a battery unit including the plurality of battery packs (the first to third battery packs 20, 30, and 40) connected in parallel, including at least one of the battery modules (the first to third battery modules 21, 31, and 41), which are rechargeable batteries, and the input-output section 13 that inputs and outputs power to the battery unit. At least one of the plurality of battery packs is an battery pack with resistor including a resistor (the first to third resistors 24, 34, and 44) connected in series to battery module, the series relay (the first to third series relay 23, 33, and 43) connected in series to the resistor and turns wiring connections on and off, and the parallel relay (the first to third parallel relay 22, 32, and 42).

The battery control device 9 includes the relay control unit 15, which turns on and off the series relay and the parallel relay, and the input-output control unit 16, which controls the input/output power between the input-output section 13 and the battery unit. The input-output control unit 16 controls the input/output power between the input-output section 13 and the battery unit when the relay control unit 15 performs the voltage adjustment sequence to adjust the voltage difference between the plurality of battery packs by turning on and off the series relay and the parallel relay, so that the circulation current is suppressed based on the direction of the circulation current and the magnitude of the circulation current. Therefore, the voltage adjustment sequence is performed while the circulation current is suppressed, and the load on the relay when turning on or off the relay to adjust the voltage of the battery circuit 10 is suppressed. As a result, the life of the relay is ensured, which contributes to reducing replacement costs. In addition, it is possible to use the relay in which capacity is smaller, contributing to lower component costs.

In the voltage adjustment sequence, the relay control unit 15 turns off the parallel relay after turning on the series relay when the current flowing through at least one of the battery packs with resistor becomes less than the predetermined current switching threshold. Therefore, each relay is turned on or off while the load to each relay is suppressed, and the life of the relay is ensured.

The relay control unit 15, when the input-output control unit controls the input-output section so that the discharge current flows from the battery unit, switches the current path by turning on and off the series relay or the parallel relay included in the battery pack with resistor in which the direction of the circulation current is the charge direction. On the other hand, the relay control unit 15, when the input-output control unit controls the input-output section so that the charge current flows to the battery unit, switches the current path by turning on and off the series relay or the parallel relay included in the battery pack with resistor in which the direction of the circulation current is the discharge direction. By switching the current path so that the direction of the circulation current and direction of the input/output power are opposite, it is possible to use the input/output power as the circulation canceling current.

The battery unit may include at least three battery packs with respective resistor connected in parallel with each other. In this case, the input-output control unit 16 is preferably configured to control the input/output power by the input-output section so that the current flowing in the battery pack with resistor in which the magnitude of the circulation current is smallest among the at least three battery packs with respective resistor included in the battery unit is less than the current switching threshold. The input/output power by the input-output section 13 is suppressed to a minimum and the voltage adjustment sequence is performed while the input/output power by input-output section 13 is minimized. Furthermore, the input-output control unit 16 may be configured to determine whether the current from the input-output section to the battery unit is the charging current or the discharging current according to the direction of the current flowing through the series relay or the parallel relay included in the battery pack with resistor in which the magnitude of circulation current is smallest.

After the relay control unit 15 turns on the series relay and tuns off the parallel relay, the input-output control unit 16 may be configured to control the input-output section 13 to stop inputting or outputting power adjusted to suppress the circulation current. Since the input/output current is stopped after the current path is made to include a resistance, the large current that flows when the input/output current is stopped is suppressed.

The resistance that the battery pack with resistor has may be adjustable based on the predetermined battery parameter that affects the circulation current. By this configuration, the current flowing as the circulation current is effectively reduced, and the time required for voltage adjustment is shortened.

The input-output control unit 16 may be configured to estimate the direction and the magnitude of circulation current based on the voltage of the battery module or the battery pack and the internal resistance of the battery module, and to control the input-output section 13 to input or output power adjusted to suppress the circulation current when the circulation current exceeds the upper limit of the chargeable and dischargeable current of the battery module. By this control, the current flowing as the circulation current is reduced and the time required for voltage adjustment is shortened.

When the battery unit includes at least two battery packs with respective resistor connected in parallel with each other, the relay control unit 15 may be configured to change the voltage adjustment sequence in response to the battery unit load reduction request when the series relay is in the on-state, the parallel relay is in off state, and the circulation current is flowing through the resistor. For example, the relay control unit 15 may be configured to terminate the voltage adjustment sequence by turning on the parallel relay and then turning off the series relay when there is the battery unit load reduction request. By this control, in response to the battery unit load reduction request, it is possible to discharge the battery module through the current path including the parallel relay side, the current path including no resistor. The relay control unit 15 may be configured to terminate the voltage adjustment sequence by turning off the series relay when there is no battery unit load reduction request. This avoids unnecessarily performing the process of turning on the parallel relay. Furthermore, the relay control unit 15 may be configured to estimate the estimated value of the circulation current in a case that the parallel relay is turned on when the series relay is in the on-state, and turns on the parallel relay when the estimated value of the circulation current becomes less than the upper limit of the charge/dischargeable current of battery module. By this control, it is possible to reduce the circulation current and shorten the period for the voltage adjustment sequence.

When there is the battery unit load reduction request when the series relay is in the on-state, the input-output control unit 16 may be configured to control the input-output section 13 to input/output power adjusted to suppress circulation current, and the relay control unit 15 may be configured to turn on the parallel relay after the series relay is turned off. By this control, the load to each relay is suppressed and the life of the relay is ensured, since turning on or off each relay is performed when the circulation current is suppressed.

The battery control device 9 may be configured to perform the battery control process performed by each of the configurations described above by performing a battery control program. The battery control program causes the computer to perform the relay control step to turn on and off the series relay and the parallel relay and the input-output control step to control the input/output power between input-output section 13 and battery unit. The input-output control step, when performing the voltage adjustment sequence to adjust the voltage difference between the plurality of battery packs by turning on and off the series relay and the parallel relay in the relay control step, suppresses the circulation current based on the circulation current direction, which is the current direction of the circulation current flowing between the plurality of battery packs, and the magnitude of the circulation current, so that the circulation current is suppressed.

The control unit and the method described in this disclosure may be realized by a dedicated computer provided by configuring a processor and memory programmed to perform one or more functions embodied by a computer program. Alternatively, the control section and methods described in this disclosure may be realized by a dedicated computer provided by configuring a processor with one or more dedicated hardware logic circuits. Alternatively, the control section and its methods described in this disclosure may be realized by one or more dedicated computers provided by a combination of a processor and memory programmed to perform one or more functions and a processor configured by one or more hardware logic circuits. The computer program may also be stored in a computer-readable, non-transitory recording medium as instructions to be executed by a computer.

The following is a description of the characteristic configurations extracted from each of the above-mentioned embodiments.

### Configuration 1

A battery control device (9) that controls a battery circuit (10) that includes a battery unit including a plurality of battery packs (20, 30, 40) connected in parallel and an input-output section (13) that inputs and/or outputs power to and/or from the battery unit,
wherein each of the plurality of battery packs includes at least one battery module (21, 31, 41) that is a rechargeable battery,
at least one of the plurality of battery packs is a battery pack with a resistor that includes: the resistor (24, 34, 44) connected in series to the battery module; a series relay (23, 33, 43) connected in series to the resistor that turns wiring connections on and off; and a parallel relay (22, 32, 42) connected in parallel with the resistor and the series relay that turns wiring connections on and off,
the battery control device includes:
a relay control unit (15), that turns on and off the series relay and the parallel relay; and
an input-output control unit (16), that controls an input and output power between the input-output section and the battery unit, and
the input-output control unit, when the relay control unit performs a voltage adjustment sequence to adjust the voltage difference between the plurality of battery packs by turning on and off the series relay and the parallel relay, controls input-output section to input or output power adjusted to suppress a circulation current based on a direction and a magnitude of the circulation current.

### Configuration 2

The battery control device according to configuration 1, wherein
the relay control unit, when performing the voltage adjustment sequence, turns off the parallel relay after turning on the series relay when the current through at least one of the plurality of battery packs with the resistor becomes less than or equal to a predetermined current switching threshold.

### Configuration 3

The battery control device according to configuration 2, wherein
the relay control unit, when the input-output control unit controls the input-output section so that the discharge current flows from the battery unit to the input-output section, and when the circulation current flowing through the battery pack with the resistor in which a direction of the circulation current is a charge direction becomes less than or equal to the predetermined current switching threshold, turns off the parallel relay included in the battery pack with the resistor in which a direction of the circulation current is the charge direction after turning on the series relay included in the battery pack with the resistor in which a direction of the circulation current is the charge direction.

### Configuration 4

The battery control device according to configuration 2, wherein
the relay control unit, when the input-output control unit controls the input-output section so that the charge current flows from the input-output section to the battery unit, and when the circulation current flowing through the battery pack with the resistor in which a direction of the circulation current is a discharge direction becomes less than or equal to the predetermined current switching threshold, turns off the parallel relay included in the battery pack with the resistor in which a direction of the circulation current is the discharge direction after turning on the series relay included in the battery pack with the resistor in which a direction of the circulation current is the discharge direction.

### Configuration 5

The battery control device according to configuration 2, wherein
the battery unit includes at least three battery packs with respective resistor, the at least three battery packs being connected in parallel with each other, and
the input-output control unit controls the input/output power by the input-output section so that the current flowing through the battery pack with resistor in which the magnitude of the circulation current is smallest among at least three battery pack with resistors in the battery unit becomes less than or equal to the current switching threshold.

### Configuration 6

The battery control device according to configuration 5, wherein
the input-output control unit determines to control the input-output section so that the charge current flows from the input-output section to the battery unit or the discharge current flows from the battery unit to the input-output section, based on a direction of a current flowing through the series relay or the parallel relay included in the battery pack with resistor in which the magnitude of the circulation current is smallest among at least three battery pack with resistors in the battery unit.

### Configuration 7

The battery control device according to any one of configurations 2-6, wherein
the input-output control unit, after the relay control unit turns off the parallel relay after turning on the series relay, controls the input-output section to stop inputting or outputting power adjusted to suppress the circulation current.

### Configuration 8

The battery control device according to any one of configurations 1-6, wherein
the resistor provided by the battery pack with resistor is adjustable in resistance value based on predetermined battery parameters affecting the circulation current.

### Configuration 9

The battery control device according to any one of configurations 1-6, wherein the input-output control unit estimates the direction and the magnitude of circulation current based on a voltage of the battery module or the battery pack and an internal resistance of the battery module, and controls the input-output section to input or output power adjusted to suppress the circulation current when the magnitude of the circulation current exceeds the upper limit of charge/discharge current of the battery module.

### Configuration 10

The battery control device according to any one of configurations 1 to 6, wherein
the battery unit includes at least two battery packs with respective resistor, the at least two battery packs being connected in parallel with each other, and
the relay control unit changes the voltage adjustment sequence in response to the battery unit load reduction request when the series relay is on-state, the parallel relay is off-state, and the circulation current is flowing through the resistor.

### Configuration 11

The battery control device according to configuration 10, wherein
the relay control unit terminates the voltage adjustment sequence by turning off the series relay after turning on the parallel relay when there is the battery unit load reduction request.

### Configuration 12

The battery control device according to configuration 10, wherein
the relay control unit terminates the voltage adjustment sequence by turning off the series relay when there is no battery unit load reduction request.

### Configuration 13

The battery control device according to configuration 10, wherein
there relay control unit estimates the estimated value of the magnitude of the circulation current when the parallel relay is turned on while the series relay is in the on-state and turns on the parallel relay when the estimated value becomes less than or equal to the upper limit of charge/discharge current of battery module.

### Configuration 14

The battery control device according to configuration 10, wherein
when there is the battery unit load reduction request while the series relay is in the on-state: the input-output control unit controls the input-output section to input or output power adjusted to suppress the circulation current; and the relay control unit turns on the parallel relay after turning off the series relay.

Although this disclosure has been described in accordance with examples, it is understood that this disclosure is not limited to said examples or structures. The present disclosure also encompasses various variations and transformations within the scope of equality. In addition, various combinations and forms, as well as other combinations and forms including only one element, more or less, thereof, also fall within the scope and idea of this disclosure.

What is claimed is:

1. A battery control device that controls a battery circuit that comprises a battery unit including a plurality of battery packs connected in parallel and an input-output section that inputs and/or outputs power to and/or from the battery unit,
wherein each of the plurality of battery packs includes at least one battery module that is a rechargeable battery,
at least one of the plurality of battery packs is a battery pack with a resistor that includes: the resistor connected in series to the battery module; a series relay connected in series to the resistor that turns wiring connections on and off; and a parallel relay connected in parallel with the resistor and the series relay that turns wiring connections on and off,
the battery control device comprises:
a relay control unit, that turns on and off the series relay and the parallel relay; and
an input-output control unit, that controls an input and output power between the input-output section and the battery unit, and
the input-output control unit, when the relay control unit performs a voltage adjustment sequence to adjust the voltage difference between the plurality of battery packs by turning on and off the series relay and the parallel relay, controls input-output section to input or output power adjusted to suppress a circulation current based on a direction and a magnitude of the circulation current.

2. The battery control device according to claim 1, wherein
the relay control unit, when performing the voltage adjustment sequence, turns off the parallel relay after turning on the series relay when the current through at least one of the plurality of battery packs with the resistor becomes less than or equal to a predetermined current switching threshold.

3. The battery control device according to claim 2, wherein
the relay control unit, when the input-output control unit controls the input-output section so that the discharge current flows from the battery unit to the input-output section, and when the circulation current flowing through the battery pack with the resistor in which a direction of the circulation current is a charge direction becomes less than or equal to the predetermined current switching threshold, turns off the parallel relay included in the battery pack with the resistor in which a direction of the circulation current is the charge direction after turning on the series relay included in the battery pack with the resistor in which a direction of the circulation current is the charge direction.

4. The battery control device according to claim 2, wherein
the relay control unit, when the input-output control unit controls the input-output section so that the charge current flows from the input-output section to the battery unit, and when the circulation current flowing through the battery pack with the resistor in which a direction of the circulation current is a discharge direction becomes less than or equal to the predetermined current switching threshold, turns off the parallel relay included in the battery pack with the resistor in which a direction of the circulation current is the discharge direction after turning on the series relay included in the battery pack with the resistor in which a direction of the circulation current is the discharge direction.

5. The battery control device according to claim 2, wherein
the battery unit includes at least three battery packs with respective resistor, the at least three battery packs being connected in parallel with each other, and
the input-output control unit controls the input/output power by the input-output section so that the current flowing through the battery pack with resistor in which the magnitude of the circulation current is smallest among at least three battery pack with resistors in the battery unit becomes less than or equal to the current switching threshold.

6. The battery control device according to claim 5, wherein
the input-output control unit determines to control the input-output section so that the charge current flows from the input-output section to the battery unit or the discharge current flows from the battery unit to the input-output section, based on a direction of a current flowing through the series relay or the parallel relay included in the battery pack with resistor in which the magnitude of the circulation current is smallest among at least three battery pack with resistors in the battery unit.

7. The battery control device according to claim 2, wherein
the input-output control unit, after the relay control unit turns off the parallel relay after turning on the series relay, controls the input-output section to stop inputting or outputting power adjusted to suppress the circulation current.

8. The battery control device according to claim 1, wherein
the resistor provided by the battery pack with resistor is adjustable in resistance value based on predetermined battery parameters affecting the circulation current.

9. The battery control device according to claim 1, wherein
the input-output control unit estimates the direction and the magnitude of circulation current based on a voltage of the battery module or the battery pack and an internal resistance of the battery module, and controls the input-output section to input or output power adjusted to suppress the circulation current when the magnitude of the circulation current exceeds the upper limit of charge/discharge current of the battery module.

10. The battery control device according to claim 1, wherein
the battery unit includes at least two battery packs with respective resistor, the at least two battery packs being connected in parallel with each other, and
the relay control unit changes the voltage adjustment sequence in response to the battery unit load reduction request when the series relay is on-state, the parallel relay is off-state, and the circulation current is flowing through the resistor.

11. The battery control device according to claim 10, wherein
the relay control unit terminates the voltage adjustment sequence by turning off the series relay after turning on the parallel relay when there is the battery unit load reduction request.

12. The battery control device according to claim 10, wherein
the relay control unit terminates the voltage adjustment sequence by turning off the series relay when there is no battery unit load reduction request.

13. The battery control device according to claim 10, wherein
there relay control unit estimates the estimated value of the magnitude of the circulation current when the parallel relay is turned on while the series relay is in the on-state and turns on the parallel relay when the estimated value becomes less than or equal to the upper limit of charge/discharge current of battery module.

14. The battery control device according to claim 10, wherein
when there is the battery unit load reduction request while the series relay is in the on-state: the input-output control unit controls the input-output section to input or output power adjusted to suppress the circulation current; and the relay control unit turns on the parallel relay after turning off the series relay.

15. A non-transitory computer-readable storage medium storing a program applied to a battery circuit that comprises a battery unit including a plurality of battery packs connected in parallel and an input-output section that inputs and/or outputs power to and/or from the battery unit,
wherein each of the plurality of battery packs includes at least one battery module that is a rechargeable battery,
at least one of the plurality of battery packs is a battery pack with a resistor that includes: the resistor connected in series to the battery module; a series relay connected in series to the resistor that turns wiring connections on and off; and a parallel relay connected in parallel with the resistor and the series relay that turns wiring connections on and off,
the program causes a computer to perform:
a relay control step for turning on and off the series relay and the parallel relay; and
an input-output control step for controlling an input and output power between the input-output section and the battery unit, and
the input-output control step includes, when a voltage adjustment sequence to adjust the voltage difference between the plurality of battery packs by turning on and off the series relay and the parallel relay is performed in the relay control step, controlling the input-output section to input or output power adjusted to suppress a circulation current based on a direction and a magnitude of the circulation current.
